(19) United States
(12) Patent Application Publication
(10) Pub. No.: US 2012/0101852 A1
(43) Pub. Date: Apr. 26, 2012

(54) SYSTEM AND METHOD FOR DETERMINING INSURANCE ADJUSTMENTS BASED ON A LIFE EVENT

(75) Inventor: Victoria F. Albert, Guilford, CT (US)

(73) Assignee: Hartford Fire Insurance Company, Hartford, CT (US)

(21) Appl. No.: 12/911,385

(22) Filed: Oct. 25, 2010

(51) Int. Cl. G06Q 40/00

(52) U.S. Cl. 705/4

(57) ABSTRACT

A system and method are disclosed herein for determining an insurance policy adjustment based on information indicative of life events. The system includes a server, a database, and a business logic computer. The database receives from a user an indication of an occurrence of a life event experienced by the user. The database stores insurance parameter data associated with the user. The business logic computer communicates with the server and database. The business logic computer can receive the user indication via the server and poses questions to send to the user based on the indicated life event. The business logic computer can send the questions to the user via the server. After receiving the user's answers to the questions, the business logic computer determines an insurance policy adjustment based on the answers and the indicated life event.

### BACKGROUND OF THE INVENTION

When a customer is seeking insurance from an insurance company, the insurance company generally requests various information from the customer for determining the appropriate policy for the customer. Such information about a customer is typically stored in the insurance company's database as insurance related data, which includes data that is directly related to various insurance parameters, or factors or criteria, as typically used by an insurance agent for determining the exact terms and conditions of the appropriate insurance policy, coverages, and their limits. However, specific information needed from a customer depends on the kind of insurance that a customer is seeking. This is because each type of insurance coverage is associated with a different set of parameters, or criteria, and specific information about a customer that is related to these parameters is used by an insurance agent to determine the exact terms and conditions of his/her insurance policy.

For example, auto insurance related insurance parameters may include the age and gender of the car owner, the year, make, and model of the car as well as the number of secondary drivers that may operate the car, and address of the place in which the car is parked overnight. For another example, insurance parameters for a home owner's insurance may include the property value of the home, address of the home, neighborhood data, and any other information. However, because each customer is associated with his/her unique insurance related data, an insurance agent uses a customer's insurance data to best determine the specific terms and conditions of his/her policy. An insurance underwriter uses information about each customer to determine a monthly premium for a particular insurance policy. For example, an insurance underwriter may decide that a customer with a 2006 Honda Accord with no secondary drivers needs to pay $130 in monthly auto insurance premium while another customer needs to pay $100 in monthly premium to insure a 2000 Toyota Camry with an additional driver. Such insurance parameters, or criteria, associated with a certain kind of insurance, such as the year, make, and model of a car associated with an auto insurance, are referred to hereinafter as “insurance parameters”. Specific information about a customer that is related to these insurance parameters associated with a certain insurance policy is referred to as “parameter data”. For example, as used herein, the fact that a customer's vehicle is a Honda Accord is the parameter data for the insurance parameter “vehicle make and model”.

After obtaining a policy, it is common for a policyholder's parameter data to change due to the occurrence of a significant life event, which may trigger adjustments in terms and condition of the policy. For example, after a policyholder has gotten married, a secondary driver would need to be added to the existing auto insurance policy as the policyholder's spouse is expected to operate the insured vehicle. Accordingly, an insurance company or a third-party insurance underwriter may decide to increase the monthly premium after receiving a notification of such a change. Other examples of life events that may trigger changes in parameter data include: having a baby, getting separated or divorced, having a family member move out (e.g., going to college), moving, changing job(s), purchasing a new pet, and the like. Accordingly, it is imperative for an insurance company to receive the updated parameter data from policyholders so that the insurance company can determine the appropriate policy adjustments, if any, to make sure the policy holders are adequately covered.

An experienced insurance agent can guide a policyholder through various questions targeted to obtain information related to any potential changes in parameter data to determine policy adjustments. Insurance underwriters use updated insurance information about policyholders to verify, accept, alter, or deny insurance adjustments as determined by insurance agents and to determine a monthly insurance premium for the policyholders if an adjusted policy is to be offered. Using the example in which a policyholder has gotten married, an agent would ask if the policyholder's spouse has recently moved in with the policyholder in his/her existing home. If the policyholder has moved, the agent would ask if additional assets were brought in by the spouse to determine if a home owner's insurance policy needs adjustments, e.g., increase coverage and/or premium. In some situations, the spouse may have his/her own car or a new car is purchased by the policyholder for the spouse. Accordingly, the policyholder's insurance needs to be adjusted based on additional data parameters about the spouse's car if the policyholder would like to add the new car to his/her existing auto insurance policy.

However, such a process is inefficient and requires time and effort by both the insurance agent and the policyholder. Additionally, the process is inconvenient for policyholders who wish to update their insurance policies directly without the involvement of an insurance agent or the insurance company's customer service department. In trying to solve this problem, some insurance companies offer policyholders the option to directly update their insurance coverage or personal information via the insurance company's website. For example, the company's website may enable customers to add a secondary driver to their auto policy, add a vehicle to their policy, change their home, or change their policy limits. However, these websites are typically structured for enabling specific predefined transactions, as opposed to being able to address customer needs when the customer may not know what transactions are in fact necessary or desirable. In fact, despite the availability of the above described websites, studies have shown that only a small percentage of customers successfully use such self-service systems to adjust their policies.

### SUMMARY OF THE INVENTION

Accordingly, there exists a need for an intuitive and intelligent information-gathering system that can determine and present to a policyholder questions related to a policyholder's life event and insurance parameters associated with the policyholder's one or more insurance policies. There exists another need for the system to determine changes in a policyholder's parameter data based on the policyholder's answers to the presented questions. Finally, there exists a further need for a self-service system configured to bind a policyholder to an adjusted insurance policy in which the adjustment is determined based on changes in a policyholder's parameter data resulting from a life event.

A system and method are disclosed herein for determining an insurance policy adjustment based on information indicative of life events. The system includes a server, a database, and a business logic computer. The server is configured to receive a user indication of an occurrence of a life event experienced by the user. The database is configured to store insurance parameter data associated with the user. The business logic computer communicates with the server and the database. The business logic computer is configured to receive the indication from the user via the server. In response to receiving the indication, the logic computer determines one or more questions related to the indicated life event and displays the determined questions to the user. The business logic computer then sends the questions to the user via the server. The server sends back to the business logic computer the user's answers to the questions. Based on the user's answers and the indicated life event, the business logic computer determines an insurance policy adjustment for the user. In some embodiments, an underwriting server accepts, alters, or denies the adjusted policy determined by the business logic computer. If the underwriting server accepts the adjusted policy, the user is bind to adjusted policy upon the user accepting the determined adjustment.

In some embodiments, the user indicates the occurrence of the life event by selecting from a list of pre-defined life events. Alternatively, the server can identify a life event based upon a textual description of the life event as received from the user. In one embodiment, the database stores pre-defined questions associated with each life event. The questions can be structured in a decision tree format in the database. To determine the questions to send to the user, the business logic computer can employ several methods. The business logic computer can send all the predefined questions to the user. Alternatively, the business logic computer can invoke a predictive model to identify the most relevant questions to send from the predefined questions about the life event. The business logic computer can also analyze the user's answer to a previous question to determine a next question to send to the user. The business logic computer can also estimate an answer to one of the questions by analyzing the user's parameter data stored in the database.

### BRIEF DESCRIPTION OF THE FIGURES

The methods and systems may be better understood from the following illustrative description with reference to the following drawings in which:

FIG. 1 is a block diagram of a self-service system for adjusting an insurance policy by a policyholder as a result of a life event experienced by the policyholder, according to an illustrative embodiment of the invention;

FIG. 2 is a block diagram of computer architecture suitable for the business logic computer shown in FIG. 1, according to an illustrative embodiment of the invention;

FIG. 3 is a flow chart of a method for determining an insurance policy adjustment based on user inputs, according to an illustrative embodiment of the invention;

FIG. 4 is a flow chart of a portion of the method described in FIG. 3 for determining questions related to a life event and insurance parameters using a predictive model, according to an illustrative embodiment of the invention;

FIG. 5A is a first decision tree illustrating pre-determined questions related to auto insurance and a first life event, according to an illustrative embodiment of the invention;

FIG. 5B is a second decision tree illustrating pre-determined questions related to home owners insurance and the first life event, according to an illustrative embodiment of the invention;

FIG. 6A is a third decision tree illustrating pre-determined questions related to auto insurance and a second life event, according to an illustrative embodiment of the invention;

FIG. 6B is a fourth decision tree illustrating pre-determined questions related to home owners insurance and the second life event, according to an illustrative embodiment of the invention;

FIG. 7 is a diagram of a user interface for presenting questions related to auto insurance and to the first life event and for accepting user-provided answers to the questions, according to an illustrative embodiment of the invention; and

FIGS. 8-10 are schematic diagrams of mobile devices displaying screen shots output by a user interface for obtaining information about a life event experienced by an insurance policyholder, according to an illustrative embodiment of the invention.

### DETAILED DESCRIPTION

To provide an overall understanding of the invention, certain illustrative embodiments will now be described, including systems and methods for providing questions related to a policyholder's life event for determining an insurance policy adjustment. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

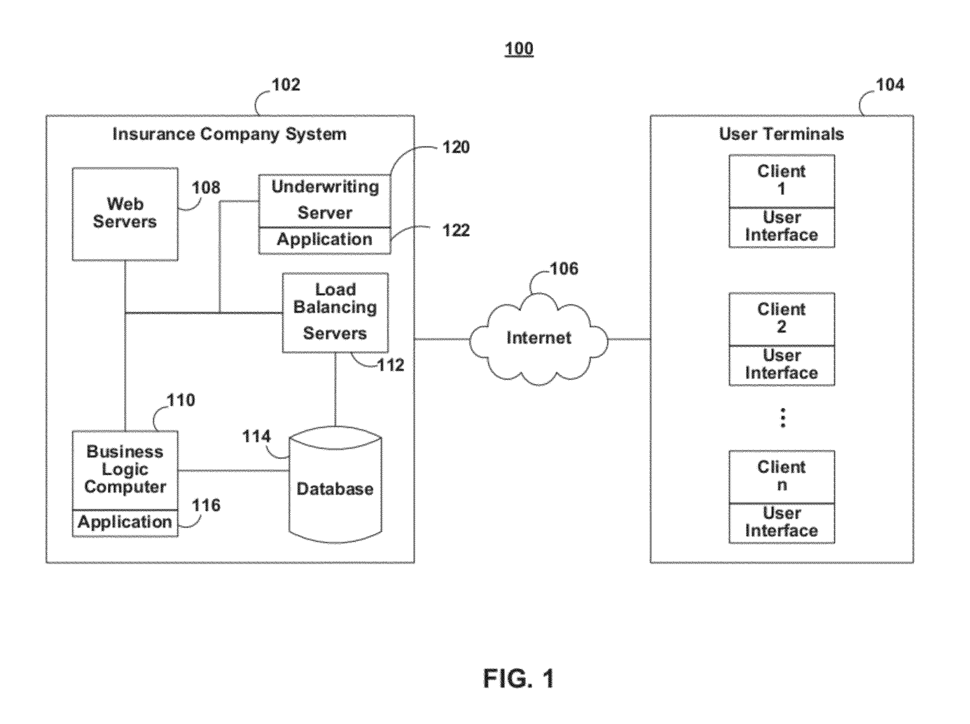

FIG. 1 is a block diagram of a self-service system 100 for adjusting an insurance policy by a policyholder as a result of a life event experienced by the policyholder, according to an illustrative embodiment of the invention. Adjusting one's insurance policy may include changing the terms and conditions for an existing policy, adding a new coverage to an existing policy, and/or obtaining a separate new policy. The self-service system is particularly well suited for a policyholder, or customer, seeking to self-adjust his/her insurance policy after a life event has occurred. A policyholder can self-adjust various kinds of insurance, such as life insurance, auto insurance, home owners insurance, and/or any other personal lines insurance. While the system 100 may primarily be used by existing policyholders for adjusting their current insurance policies, it may also be used by potential customers seeking insurance policies.

The self-service system 100 includes an insurance company system 102 in communication with user terminals 104 via internet 106. The insurance company system 102 includes several web servers 108, business logic computer 110, which hosts one or more applications 116 (hereinafter application 116), load balancing servers 112, a database 114, and an underwriting server 120, which hosts an underwriting application 122. The load balancing servers 112 balance the workload among the servers of the computer system 102, according to various methods well known in the art of content delivery and load management. The web servers 108 communicate with and provide data to the user terminals 104 according to various data exchange protocols, such as http.

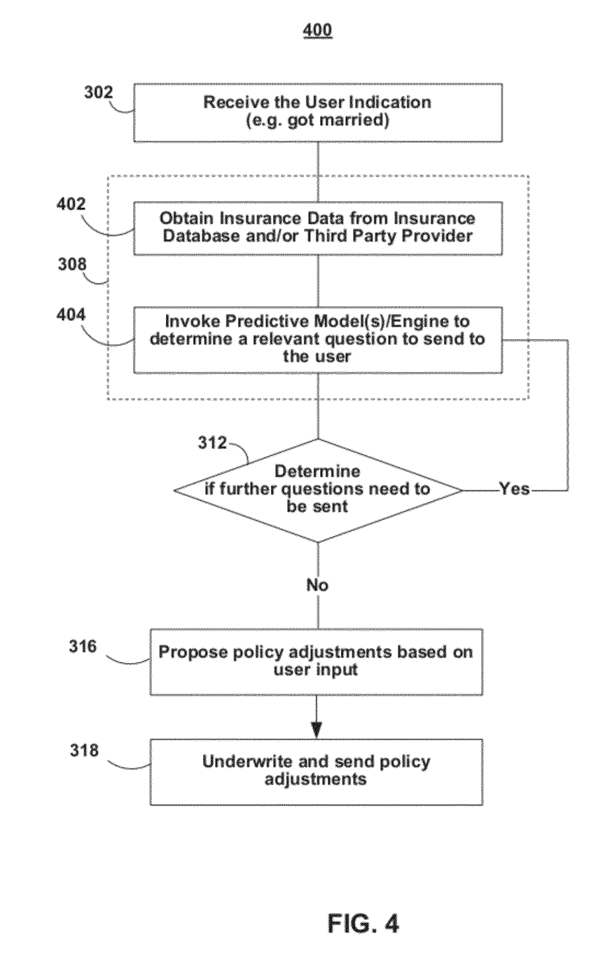

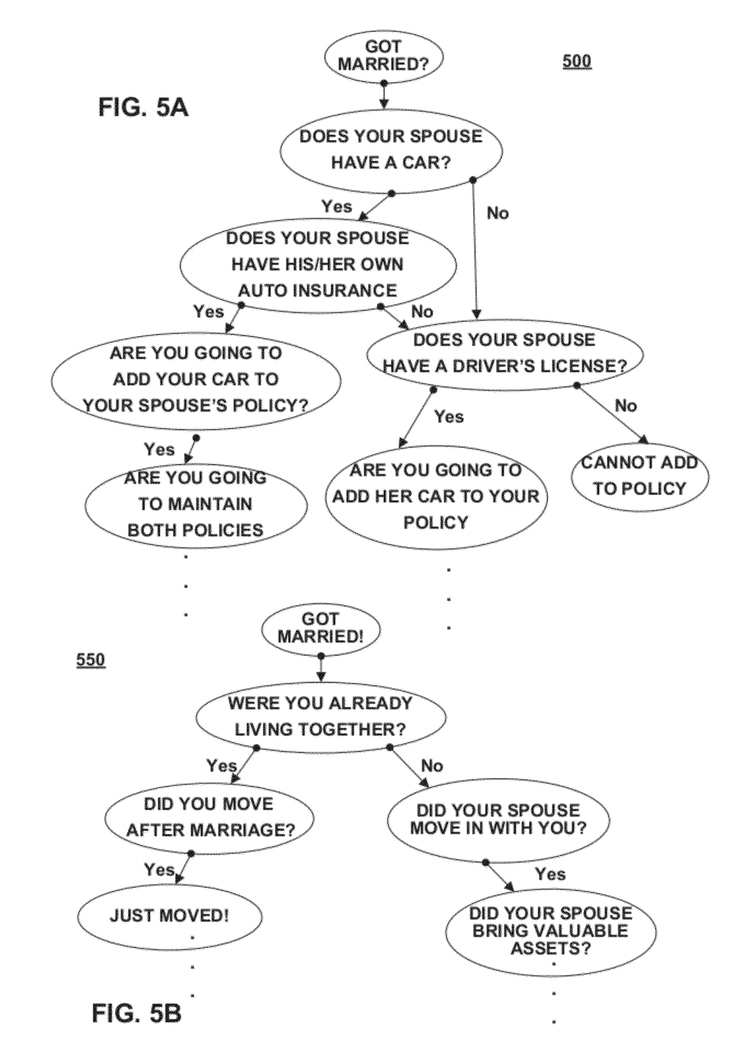

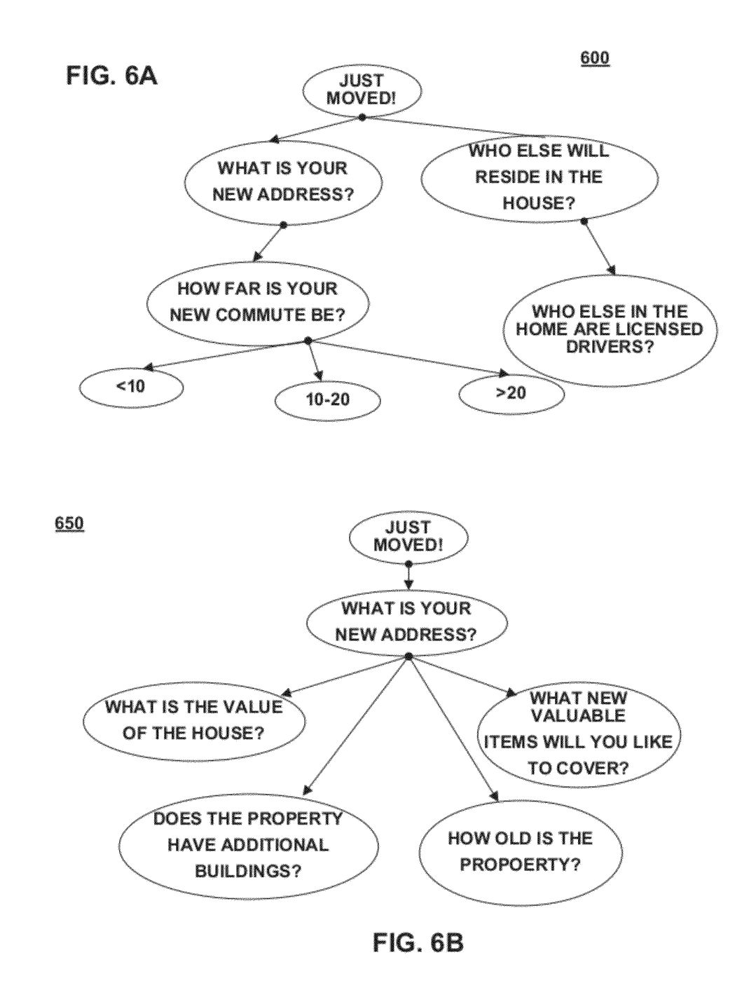

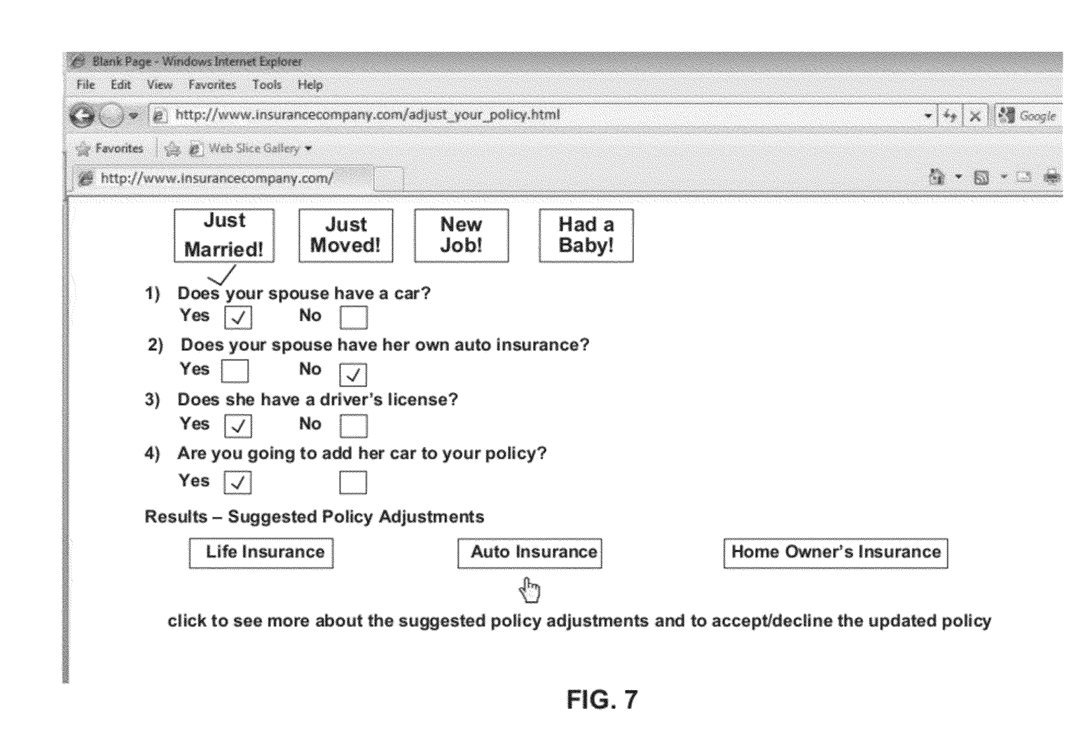

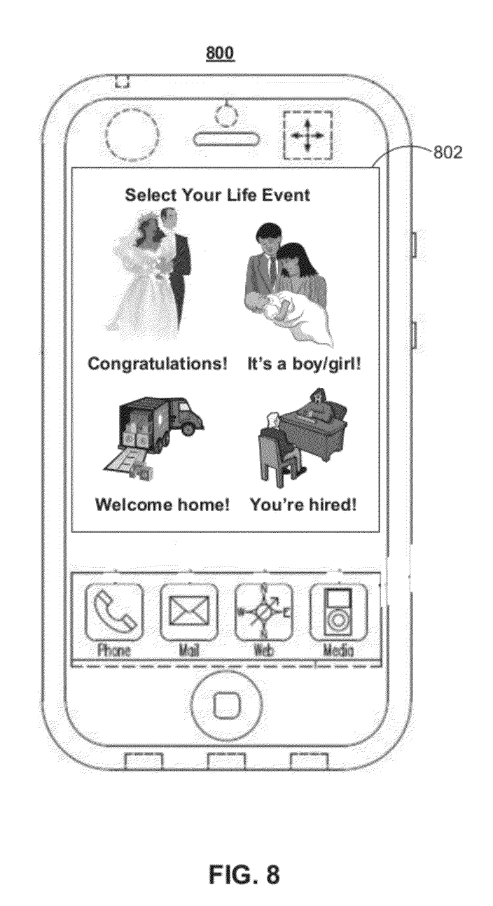

The business logic computer 110 may be a server, a computer, and/or any other computing devices capable of making various decision analyses by invoking the appropriate application, such as the application 116. The application 116 contains computer executable program code for determining questions to present to a policyholder, or user, in response to receiving from the user an indication and selection of a life event via the terminals 104. The application 116 determines questions to present to the user based on various factors, such as the nature of the life event, answers to previous questions, parameter data and/or any other data about the user. In some embodiments, the application 116 includes program code for a predictive model for dynamically determining questions related to a user's life event and insurance parameters, as described in relation to FIG. 4. Alternatively, or additionally, the application 116 can access a list of pre-determined questions related to a particular life event, as described in relation to FIGS. 5-6.

The database 114 stores various insurance parameters associated with various kinds of insurance policies used to determine a policyholder's insurance policy. For example, insurance parameters associated with auto insurance may include, without limitation, marital status, age, gender, vehicle model, vehicle age, vehicle value, customer driving records, and information about other vehicle drivers. Insurance parameters associated with a home owner's insurance may include property value, identification of valuable assets to be insured, home construction type, home age, quality of local fire protection, number of occupants and their associated personal information, location, neighborhood data, and/or any other relevant parameters or rating factors. The database 114 also stores a pre-defined list of questions for each life event, and/or any other insurance related data including any other information relevant to the determination of insurance policy adjustments. Values for each these parameters are referred to herein as “parameter data”.

The underwriting server 120 and its associated underwriting application 122 are configured to process new insurance policy requests as well as policy adjustments proposed by insurance agents or business logic computer 110 by accepting, altering, or rejecting the proposed adjustments. In the following discussion, it is assumed that the underwriting server 120 and application 122 are configured to process policy adjustments proposed by the business logic computer 110.

The underwriting server 120 may be any computing device capable of hosting and executing the underwriting application 122. In some embodiments, the logic of the underwriting application 122 is determined based on current underwriting practices used by insurance underwriters. The underwriting application 122 can process adjustments proposed by the business logic computer 110 using the updated parameter data provided by a policyholder, historical insurance data about the policyholder, third-party data as described above, and/or insurance data related to other policyholders. In some instances, the underwriting application 122 alters the insurance policy adjustments proposed by the business logic computer 110, such as to increase or decrease a coverage limit that was determined by the business logic computer 110. In other instances, the underwriting application 122 declines to offer policy adjustments proposed by the business logic computer 110.

For example, the business logic computer 110 may decide to increase a policyholder's current home insurance coverage limit because the policyholder's spouse brought in additional assets after marriage. If the coverage limit proposed by the business logic computer 110 is acceptable, the underwriting server 120 accepts the proposed adjustments. Otherwise, the underwriting server 120 either alters or rejects the proposed adjustments.

Once an adjustment is accepted the underwriting application 122 the underwriting application 122 further determines a premium that the policyholder must pay for the adjusted policy. The underwriting application 122 includes executable code for automatically determining a monthly premium. Though the foregoing discussion assumes that the underwriting application 122 underwrites policy adjustments as proposed by the business logic computer 110, the underwriting server 120 can also automatically process certain insurance adjustments determined by an insurance agent.

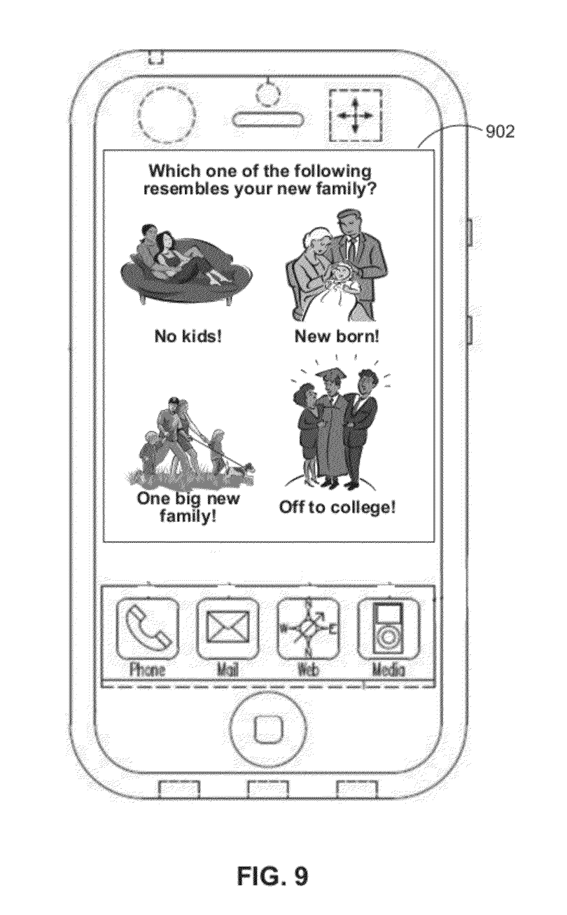

The user terminals 104 include various terminals, such as client 1, client 2, and client n. Each client has its associated user interface configured to allow a user operating the client to communicate and/or interact with the insurance company system 102 via the internet 106. The user terminals 104 can receive various data stored in the database 114 and/or determined by the business logic computer 110 via the web servers 108. If a web browser is implemented as part of the user interface of a terminal, the web browser can use data received from the web server 108 to render the graphics and/or text associated with or representative of various objects depicted in FIG. 7. A user client or terminal may be any well known computing device, such as a personal computer, a laptop, a mobile and/or cellular device, and the like. The user client or terminal may be also be implemented with a thin client application for taking advantage of a remote server to handle the primary processing workload, or implemented with a thick client application capable of handling computation-intensive processing workloads. Policyholders can send an indication and a selection of a life event to the insurance company system 102 via a user interface associated with each client.

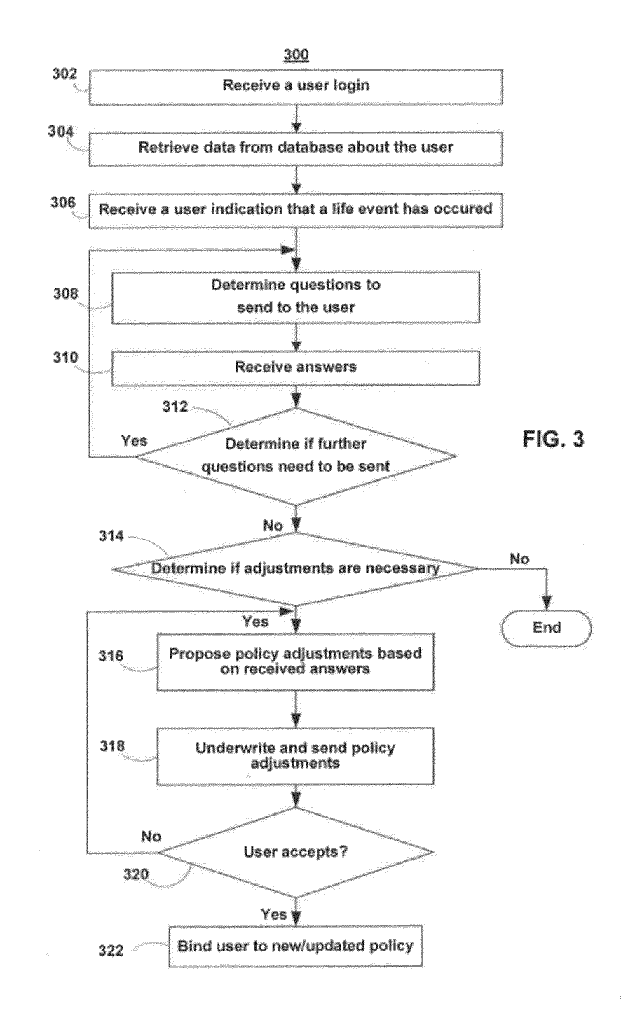

In operation, a user can indicate to the insurance company system 102 that a life event has recently occurred after logging into his/her account with the insurance company. To do so, the user can, for example, navigate to a link on the insurance company's web page to indicate that a life event has occurred. The user can either enter text representative of the life event or select from a list of life events depicted on a web page, or some other form of user interface. The web server 108 assigned to the session, as determined by the load balancing servers 112 receives the user indication and selection and forwards the received data to the business logic computer 110. If the user has entered a textual description of the life event, the business logic computer 110 can pass the entered text to the appropriate application 116 for performing data mining and/or text analysis. If the textual description matches that of one of the pre-defined life events, the application 116 selects one of the pre-defined events for the user. After receiving the user selection of a life event, the application 116 determines one or more questions to present to the user that are related to the life event and insurance parameters. As described in relation to FIGS. 3-6, a user's answers to these questions are used to automatically determine and propose insurance policy adjustments to the policyholder, if any.

The application 116 can use various methods for determining relevant questions to present to a user/policyholder. In one embodiment, the determination of a next question is dynamic in that the user's answer to a previous question determines the next question. A method for dynamic question generation is described in relation to FIG. 4. In another embodiment, questions for a particular life event are pre-defined and stored in the database 114, as described in relation to FIGS. 5-6. Accordingly, the application 116 retrieves questions from the database 114 and sends them to the web server 108 to send to the user. For some of the pre-defined questions, the application 116 can automatically determine answers to these questions based on information stored in the database 114 about the user. That is, in some instances, answers to certain pre-defined questions can be determined without user input if information about the answers is already stored in the database 114. In these instances, the application 116 can pre-filter the questions for which answers can be determined. Alternatively, these questions and their answers are presented to a user via the client's user interface. In some embodiments, the user can be given the option to correct the answers determined by the application 116. In other embodiments, the user is taken to a web page to verify and/or modify the data used by the application 116 to determine the answers. It should be noted that the application 116 can combine the above-mentioned methods in various ways for determining questions without departing from the scope of the invention.

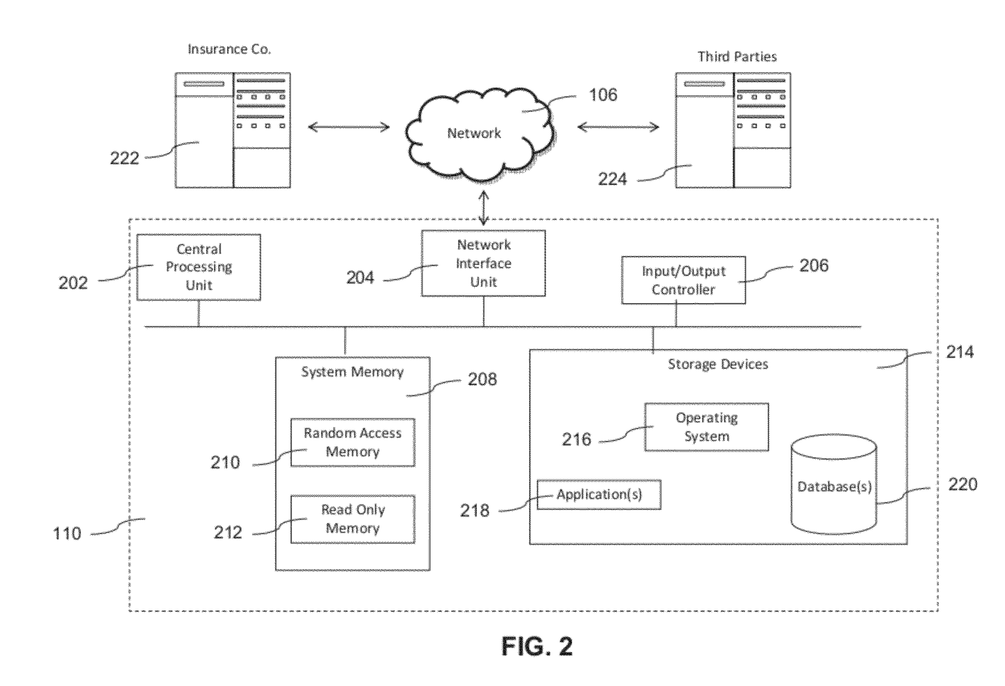

FIG. 2 is a block diagram of computer architecture suitable for the business logic computer shown in FIG. 1, according to an illustrative embodiment of the invention. Computer system 110 comprises at least one central processing unit (CPU) 202, system memory 208, which includes at least one random access memory (RAM) 210 and at least one read-only memory (ROM) 212, at least one network interface unit 204, an input/output controller 206, and one or more data storage devices 214. All of these latter elements are in communication with the CPU 202 to facilitate the operation of the computer system 110. The computer system 110 may be configured in many different ways. For example, computer system 110 may be a conventional standalone computer or alternatively, the function of computer system 110 may be distributed across multiple computing systems and architectures. In the embodiment shown in FIG. 2, the computer system 110 is linked, via network 106 (also described in FIG. 1), to an insurance company computer system 222 and one or more third party computer systems 224.

Computer system 110 may be configured in a distributed architecture, wherein databases and processors are housed in separate units or locations. Some such units perform primary processing functions and contain at a minimum, a general controller or a processor 202 and a system memory 208. In such an embodiment, each of these units is attached via the network interface unit 204 to a communications hub or port (not shown) that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, BLUETOOTH™, GSM and TCP/IP.

The CPU 202 comprises a processor, such as one or more conventional microprocessors and one or more supplementary co-processors such as math co-processors. The CPU 202 is in communication with the network interface unit 204 and the input/output controller 206, through which the CPU 202 communicates with other devices such as other servers, user terminals, or devices. The network interface unit 204 and/or the input/output controller 206 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 202 is also in communication with the data storage device 214. The data storage device 214 may comprise an appropriate combination of magnetic, optical and/or semiconductor memory, and may include, for example, RAM, ROM, flash drive, an optical disc such as a compact disc and/or a hard disk or drive. The CPU 202 and the data storage device 214 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 202 may be connected to the data storage device 214 via the network interface unit 204.

The data storage device 214 may store, for example, (i) an operating system 216 for the computer system 110; (ii) one or more applications 218 (e.g., computer program code and/or a computer program product) adapted to direct the CPU 202 in accordance with the present invention, and particularly in accordance with the processes described in detail with regard to the CPU 202; and/or (iii) database(s) 220 adapted to store information that may be utilized to store information required by the program. In some embodiments, the database(s) 220 includes a database storing auto insurance compliance guidelines for one or more jurisdictions, a database storing policy holder information, a database storing policy provisions for one or more different types of insurance policies, and/or a database storing claims information.

The operating system 216 and/or applications 218 may be stored, for example, in a compressed, an uncompiled and/or an encrypted format, and may include computer program code. The instructions of the program may be read into a main memory of the processor from a computer-readable medium other than the data storage device 214, such as from the ROM 212 or from the RAM 210. While execution of sequences of instructions in the program causes the processor 202 to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as generating relevant questions to present to a policyholder, determining a policy adjustment, and binding the policyholder to an adjusted policy. The program also may include program elements such as an operating system, a database management system and “device drivers” that allow the processor to interface with computer peripheral devices (e.g., a video display, a keyboard, a computer mouse, etc.) via the input/output controller 206.

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 202 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

FIG. 3 is a flow chart of a method 300 for determining an insurance policy adjustment based on user inputs, according to an illustrative embodiment of the invention. The method begins at step 302 by the business logic computer 110 receiving a user login from a client of the user terminals 104. At step 304, the application 116 retrieves from the database 114 data about the user. The retrieved data includes parameter data associated with the user's current policy and its policy parameters, such as the user's marital status, current street address, and/or any other insurance related data about the user and the user's policy that may be used for determining policy adjustments.

At step 306, the business logic computer 110 receives a user indication that a life event has occurred. Receiving a user indication is a multi-step process. In some embodiments, the user is first asked if the user has experienced a life event. As mentioned previously, the user can access a link on the insurance company's web page to inform the insurance company system 102 that a life event has occurred. After the user indicates that a life event has occurred, the user is further asked to identify the event that has occurred. As mentioned previously, the user can identify the event in two ways: by either entering textual descriptions of the event or by selecting from a list of pre-defined events.

Pre-defined events are determined by insurance personnel and stored in the database 114. However, in some embodiments, the pre-defined events are dynamically updated according to various well-known machine-learning algorithms. For example, over time, if the business logic computer 110 detects that multiple users have entered descriptions of a same or similar life event not previously stored in the database 114, the business logic computer 110 tags events and their descriptions so that insurance personnel can later determine if the events should be added to the list of pre-defined events. The business logic computer 110 can detect if multiple users have entered textual descriptions of the same life event by identifying and matching the key phrases contained in the descriptions. In some embodiments, the business logic computer 110 only presents life events to insurance personnel for determining if an event should be added to the database if the number of users or the number of times the description of such an event was entered exceeds a predetermined threshold value. In the following discussion, it is assumed that the user identifies a life event by way of selecting the life event from the pre-defined list of life events.

After receiving a user selection as part of step 306, the business logic computer 110 passes the user selection as a parameter to the application 116. The application 116 uses the retrieved parameter data about the user to determine questions related to the user-selected life event and the insurance parameters associated with the user's insurance policy at step 308. As discussed in the background section, users, or policyholders, may not be fully aware of all the insurance parameter data that may be changed as a result of a life event. Accordingly, the questions are determined or selected such that a policyholder's answers to these questions can be used by the business logic computer 110 to identify the changes in policyholder's parameter data as a result of the life event. The business logic computer 110 can then use information about the changes in parameter data, if any, to determine whether insurance adjustments are necessary and if so what the adjustments should be. Therefore, the questions need to be constructed in such a way that they are related both to the life event as selected by the user and the insurance parameters used to determine the user's existing policy.

In some embodiments, the application 116 automatically retrieves pre-stored questions. In other embodiments, to make the information-gathering experience more intuitive and user friendly, questions to present to the user are dynamically determined. A process for dynamically determining questions is described in relation to FIG. 4. At step 310, the application 116 receives an answer from the user in response to a question that was sent at step 308. The application 116 then determines, at step 312, if further questions need to be sent. If so, the application 116 returns to step 308 for determining more questions to send to the user. If no further questions need to be sent, the application 116 determines, at step 314, if insurance policy adjustments are necessary based on answers received from a policyholder. If information received from a policyholder is not sufficient to trigger policy adjustments, the process ends.

However, if the application 116 determines that policy adjustments are necessary, the application 116 proposes, or determines, policy adjustments based on answers received from a policyholder at step 316. One suitable system and method for automatically determining insurance policy provisions based on various factors is described in co-pending U.S. patent application Ser. No. 11/961,380, the entirety of which is incorporated herein by reference. As mentioned previously, an adjustment may include changing one or more coverages of an existing insurance policy, changing the policy premium, and/or adding a new policy. The business logic computer 110 sends the proposed policy adjustments to the underwriting server 120. The underwriting application 122 is then invoked by the receipt of the proposed adjustments. At step 318, the underwriting application 122 underwrites the policy adjustments. As discussed in relation to FIG. 1, the underwriting application 122 may accept, alter, or decline the adjustments proposed by the application 116. Once final policy adjustments are determined and underwritten by the underwriting application 122, the policy adjustments are sent to the policyholder for review, also at step 318.

At step 320, the user can either accept or decline a recommended adjustment. If the user accepts the adjustment, the insurance company system 100 automatically binds the user to the updated policy at step 322. Alternatively, if the user declines the proposed adjustment, the business logic computer 110 returns to step 316 and can propose a different adjustment, if applicable, to offer to the user. If the number of times that the user has declined a proposed adjustment exceeds a threshold value, the process ends. In such cases, the business logic computer 110 notifies the appropriate insurance personnel and sends the personnel a report containing the information gathered from the user. This way, the insurance personnel can verify the determined adjustment that was declined by the user and/or propose a new adjustment to present to the user.

FIG. 4 is a flow chart of a portion of the method 400 described in FIG. 3 for determining questions related to a life event and insurance parameters using a predictive model, according to an illustrative embodiment of the invention. As described above, the business logic computer 110 determines questions related to a user selected life event according to several methods. According to the method 400, the business logic computer 110 can invoke a predictive model for dynamically determining questions. The model is associated with executable instructions or program code that is part of the application 116. After receiving the appropriate input parameters, the business logic computer 110 can execute the application 116 or the portion of the application 116 that contains the executable instructions for the model. To determine a next question, the predictive model, or the application 116, uses the received input parameters and/or a user's answer to a previous question to identify a most relevant question to present to the user. In some embodiments, the predictive model identifies relevant questions by selecting appropriate questions from a pre-defined list of questions associated with a particular life event. Accordingly, the application 116 tracks the progress of the questionnaire-and-answering session of a user so that questions already presented to the user are removed from the list of questions considered for the next question. The application 116 can also customize the presentation of questions identified or determined by the predictive model. The customization may be based on a policyholder's profile or preference set by the policyholder. For example, certain questions may be phrased in a gender specific manner to improve the overall user experience.

As mentioned previously, the method 400 is a portion of the method 300 and describes in detail the processing steps involved in step 308. The method 400 begins at step 402 by the application 116 obtaining insurance data from the database 114 and/or from a third party data provider via the web servers 108. The obtained data includes, in addition to the data described in relation to FIGS. 1 and 3, the user's answer to a question, if applicable, as well as any available third party data about the user, such as data obtained from the departments of motor vehicles, federal and state census bureaus, news sources, registry of deeds, secretary of state offices, clerks offices, and/or any other information about the user and the user's life event that is relevant in determining an adjustment, if any. The obtained data is fed into the application 116 as input parameters. After receiving the data, the business logic computer 110 invokes the application 116 that corresponds to the predictive model for determining a relevant question to send to the user at step 404. Details for using a predictive model for intelligent decision-making are described in co-pending patent application Ser. No. 11/961,380, the entirety of which is incorporated herein by reference. In some embodiments, a predictive model or application 116 selects questions dynamically from a list of pre-defined questions. Examples of pre-defined questions stored in the database 114 are described in relation to FIGS. 5-6.

The predictive model can be trained by insurance personnel using a set of test data including historical data stored about various policyholders and their insurance policies. For example, experienced insurance agents can identify questions that should be presented to a policyholder for a given life event or scenario. The agents can further identify answers that a user is likely to provide for each question and the questions that should be asked in response to each of the possible answers. Such information is fed into the predictive model and can be used by its algorithm to determine, for the future, questions for a given life event. Additionally, based on historical data of policyholders who have experienced various kinds of life events in the past, the insurance agents can identify the policy adjustments of these policyholders and changes in their parameter data that led to the adjustments. The associations between changes in parameter data and the resulting insurance policy adjustments are identified by the application 116 and fed into the predictive model. With the relevant training data, the insurance company system 102 can employ various training techniques well known in the art of predictive analytics to train the predictive model, such as back-propagation, quick propagation, conjugate gradient descent, projection operator, and Delta-Bar-Delta.

FIG. 5A is a first decision tree 500 illustrating pre-determined questions related to auto insurance and a first life event, according to an illustrative embodiment of the invention. The set of questions suggested are merely illustrative in nature and in no way an attempt to capture the entire set of questions which may be presented to the policyholder. In this example, a policyholder has recently gotten married and the decision tree 500 depicts various questions intended to capture information relevant to the determination of an adjustment, if any, of the policyholder's auto insurance policy. These questions may be determined by experienced insurance personnel or third party analysts. In some embodiments, the insurance company system 102 can derive these questions from historical data entered by insurance personnel about policyholders or by monitoring live interactions between agents and policyholders. The business logic computer 110 can analyze historical data about various policyholders according to various well-known data mining methods, such as the association rule learning method. For example, the business logic computer can identify parameter data that was most frequently updated in the past by an insurance agent due to a life event experienced by several policyholders. Accordingly, insurance personnel can determine questions based on the association between an insurance parameter and a life event as determined from historical data.

In this embodiment, the user has indicated to insurance company via the system 102 that he/she has just gotten married. After receiving the user selection, the business logic computer 110 queries the database 114 for a list of questions pre-defined for this scenario. A portion or all of the pre-defined questions are sent to the user via the web servers 108. As mentioned above, the predictive model can identify questions most relevant to auto insurance and/or the user-selected life event from the list to present to the user. Alternatively, all questions are presented to the user in the order as defined by the decision tree. The questions are ordered in such a way that the questions more closely related to the life event are asked first. Gradually, questions more closely related to specific insurance parameters are presented thereafter.

Following the decision tree 500, the business logic computer 110 begins with asking the policyholder if his/her spouse has auto insurance. If the spouse does, the policyholder is asked if the spouse has his/her own auto insurance, which may include one of liability, collision, or comprehensive coverages. If the spouse has auto insurance, the policyholder is then asked if he/she is going to be added to the spouse's auto insurance policy. If yes, the policyholder is further asked if he/she is going to maintain both policies, which would indicate to the logic computer 110 that the policyholder is not canceling his/her insurance. However, if the policyholder's spouse does not have auto insurance for his/her car, the computer 110 asks the policyholder if the spouse has a driver's license. If the spouse does, the policyholder is asked if he/she is going to add the spouse to his/her auto insurance, e.g., a secondary driver of the policyholder's vehicle. Otherwise, if the spouse does not have a driver's license, the business logic computer 110 determines that the spouse cannot be added to the policyholder's policy. In some instances, the policyholder is presented with the same question via a different decision-processing path. For example, if the policyholder answers that his/her spouse does not have a car, the policyholder is still asked to verify if the spouse has a driver's license.

In addition to presenting questions related to auto insurance, the same life event can result in changes to insurance parameters related to other insurance policies and/or coverage, such as home owners insurance or life insurance. FIG. 5B is a second decision tree 550 illustrating pre-determined questions related to homeowners insurance applicable upon notice that a policyholder just got married, according to an illustrative embodiment of the invention. The set of questions suggested are merely illustrative in nature and in no way an attempt to capture the entire set of questions which may be presented to the policyholder. The business logic computer 110 can present questions associated with decision trees 500 and 550 concurrently to a policyholder via a user interface. In some embodiments, the business logic computer 110 determines the order in which the two lists are presented to the user.

In this embodiment, the computer 110 begins by asking the policyholder if he/she and his/her spouse have already been living together prior to marriage. As mentioned previously, some answers to the pre-defined questions are determined based on stored data about the policyholder. For example, the policyholder may have indicated, when signing up for the current homeowners insurance, that his/her better is are residing in the same home. Accordingly, the computer 110 determines a “yes” to the question for the policyholder. In some instances, the computer 110 assigns a certainty score in percent format to an answer automatically determined by the business logic computer 110 for a question. In some embodiments, questions with certainty scores below a certain threshold value are presented to the user for verification. In other embodiments, all questions for which the computer 110 has estimated an answer are presented to the user. The computer 110 propagates the certainty scores to the end of a decision tree and calculates a total certainty score for the final decision. User-provided answers are assigned with a certainty score of 100%.

Following the tree 550, if the policyholder was living with his/her spouse before marriage, the policyholder is then asked if they have moved to a new home since their marriage. If yes, questions related to the scenario in which a policyholder has moved are presented to the policyholder, as described in relation to FIGS. 6A-6B. That is, because one life event can trigger another event, a decision tree for one life event may be intermingled with a decision tree for another. If the couple was not previously living together, the policyholder is asked if the spouse has moved in since they got married. If the spouse has, additional questions are asked, such as if the spouse has brought valuable assets to the home, for which the policyholder may need to elect new coverage should he/she wish to insure the new assets.

FIG. 6A is a third decision tree 600 illustrating pre-determined questions related to auto insurance and to a second life event, according to an illustrative embodiment of the invention. In this example, the user of the self-service system 100 has indicated that he/she has just moved. Accordingly, pre-determined questions for determining if the user's auto insurance should be adjusted are presented to the user. The set of questions suggested are merely illustrative in nature and in no way an attempt to capture the entire set of questions which may be presented to the policyholder. Following the tree 600, the user is first asked to provide the address of the new home/residence (herein after “home”). After the user provides the address of the new home, the user is asked to provide information about his/her future commute distance. The user can select one of three options: less than 10 miles, between 10 to 20 miles, or more than 20 miles. This way, the insurance company can determine if the driving distance will be increased as a result of moving to a new home, which can affect the user's auto insurance coverage and/or premium. Simultaneously or sequentially, the user is asked other questions when asked to provide the address of the new home. For example, the user may be asked to identify individual(s) who may be living in the home as these individual(s) may operate the user's insured vehicle. The user is further asked if the individual(s) are licensed drivers since un-qualified drivers should not affect the auto insurance of the user.

FIG. 6B is a fourth decision tree 650 illustrating pre-determined questions related to home owners insurance and to the second life event, according to an illustrative embodiment of the invention. The set of questions suggested are merely illustrative in nature and in no way an attempt to capture the entire set of questions which may be presented to the policyholder. In this example, the user is asked to provide the address of his/her home after indicating to the business logic computer 110 that he/she has recently moved. Accordingly, various questions related to the user's home owners insurance are retrieved from the database 114 and are presented to the user in a pre-specified order and/or simultaneously. For example, the user is asked the value of the newly purchased home. Other specifics about the home may also be asked. For example, the user is asked if the home/property has additional buildings detached from the main building of the home. The user is further asked to provide information about the age of the home. Other questions related to factors that can trigger an adjustment in the home owners insurance are presented. For example, the user may be asked to identify valuable items to be covered as many people decide to purchase new furniture for their new home.

FIG. 7 is a diagram of a user interface 700 for depicting questions related to auto insurance and to the first life event and for depicting user-provided answers to the questions, according to an illustrative embodiment of the invention. The user interface 700 may be a graphical user interface, such as a web page. The source code for the web page is received from the web servers 108 and is executed by a web browser for rendering various graphics associated with objects depicted on the web page. In this embodiment, icons depicting the various pre-defined life events are shown from which a user can select a life event that has recently occurred to the user. A user can interact with the web page according to various well known user input methods, such as by moving a cursor over an object. To select a life event, the user can click on the icon corresponding to the life event. In this embodiment, the user has selected or indicated that he/she has just gotten married. Various questions as described in relation to FIG. 5 are depicted in response to a user selecting the event.

In some embodiments, pre-defined questions appear simultaneously on the interface 700. In other embodiments, questions are dynamically generated and are, therefore, displayed as they are determined. In this illustrative embodiment, the user can select objects that correspond to Yes or No to answer a question. The user can also enter texts into an input box to provide information or answer options that cannot be pre-determined for the user, such as the user's new home address.

After answering the various questions or after providing enough information to the insurance company system 102 for determining if insurance adjustment is necessary, the business logic computer 110 determines an adjustment to the user's existing insurance policy. The suggested adjustment is outlined in a report generated automatically and can be presented to the user in response to the user clicking on one of the icons representative of the corresponding insurance policy. For example, if an adjustment is determined for the policyholder's existing auto insurance, the user can click on the icon that corresponds to the auto insurance. The policyholder is then presented with a pop-up window containing textual and/or graphical information about the suggested adjustment. Through the pop-up window, the user can choose to accept or decline the suggested adjustment. If the user accepts, the insurance company automatically binds the policyholder to the newly adjusted policy without involving insurance personnel and/or any other human interaction. It should be noted that a policyholder can receive multiple adjustments determined for multiple insurance policies. Accordingly, the policyholder can access information about these adjustments via the same user interface simultaneously. Although the illustrative embodiment is described in relation to a web page, it should be noted that the self-service system 100 could also be implemented on a mobile device and/or cellular device so that a user's insurance policy can be adjusted on the go. In some embodiments, a user's progress in the questionnaire is tracked so that the user can answer a portion of the questions tailored to the life event via multiple devices.

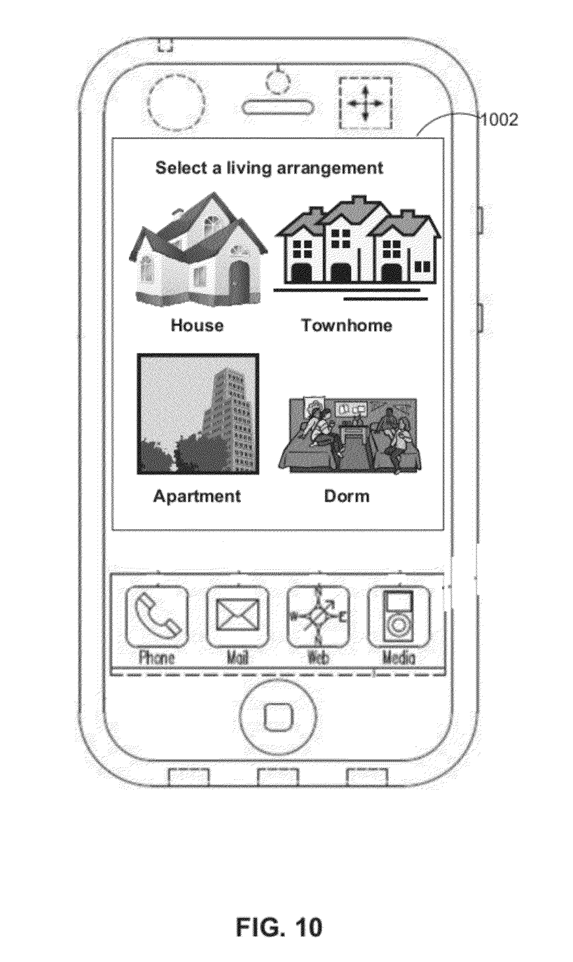

FIGS. 8-10 are schematic diagrams of mobile devices displaying screen shots output by a user interface 800 for obtaining information about a life event experienced by an insurance policy holder The user interface 800 may be an interactive graphical user interface substantially similar to the interface 700 as described above. In contrast to the user interface 700, however, the user interface 800 presents possible answers to presented questions pictorially. For example, in some embodiments, instead of depicting life events via textual description, the life events are depicted graphically for a more intuitive and friendly user experience. For example, as depicted on the user interface 800, graphical representations corresponding to “Just got married!”, “Had a baby!”, “Just moved!”, and “Got a new job!” are presented, instead of the textual representations of these events as depicted on the interface 700. A web browser suitable for mobile devices is configured to render graphics associated with these graphical representations. Alternatively, the user interface may be included as a part of a standalone insurance application installed on the mobile device. A user can select a life event by interacting with the interface 800 according to various well-known user input methods associated with mobile devices, such as by tapping on a touch screen with a finger or stylus or navigating to the appropriate region on the screen using a trackball. Once a user selection of a life event is received by the insurance company system 102, the web browser or insurance application implemented on the mobile device receives from the system 102 additional data needed for rendering subsequent screenshots as depicted in FIGS. 9 and 10.

If a policyholder selects he/she has just gotten married via the interface 800, the interface 800 depicts the screenshot 902 in which various family make-ups are presented. The policyholder can select the graphical representation that best resembles his/her current family make-up. For instance, policyholders who are recently married but do not have kids can select the picture representative of a family with no kids. Other family make-ups depicted in FIG. 9 include a family with a newborn, a new family with children from couples' previous relationships, and a new family in which the child is leaving for college. Depending on the family make-up as selected by a policyholder, the insurance company system 102 uses the selection to determine additional questions to present to the policyholder. For instance, if a policyholder indicates that a child of his/her spouse is leaving for college, the insurance company system 102 may ask the policyholder if he/she is interested in purchasing auto insurance for the child.

FIG. 10 is a schematic diagram of the mobile device displaying another screen shot 1002 for depicting various living arrangements that a policyholder may select from, according to an illustrative embodiment of the invention. In response to receiving an indication from a policyholder that he/she just got married via the interface 800, the system 102 determines that the policyholder's current living arrangement may change as a result. Accordingly, the screen shot 1002 depicts various living arrangements that may represent the policyholder's new living arrangement, including a house, a townhome, an apartment, and a dorm. Depending on the arrangement as selected by a policyholder, the insurance company system 102 determines questions specific to a particular living arrangement to present to the policyholder. For example, if a policyholder selects house or townhome as his/her current living arrangement, the insurance company system 102 can present questions related to a home owner's insurance. If a policyholder selects apartment, a different set of questions related to renters insurance may be presented in the form of text, graphics, or both. The system 102 may also present the screen shot 1002 in response to receiving an indication of other life events or in response to other answers provided by policyholders that the policyholder has recently moved.

The invention may be embodied in other specific forms without departing from the spirit or essential characteristics thereof. Therefore, the foregoing embodiments are to be considered in all respects illustrative, rather than limiting of the invention.

What is claimed is:

1. A system for determining an insurance policy adjustment based on information indicative of life events, comprising
a server configured to receive a user indication of an occurrence of a life event experienced by the user,
a database configured to store insurance parameter data associated with the user; and
a business logic computer in communication with the server and the database, configured to
receive the indication from the user via the server,
in response to receiving the indication, display one or more questions related to the indicated life event,
send the one or more questions to the user via the server,
receive from the user one or more answers associated with the one or more questions via the server, and
determine an insurance policy adjustment for the user's one or more insurance based on the one or more user answers and the indicated life event.

2. The system of claim 1, wherein the server is further configured to receive a user selection of one of a pre-defined list of life events.

3. The system of claim 2, wherein the predefined list of life events comprises at least two of getting married, getting divorced, and having a family member move out of the home.

4. The system of claim 1, wherein the business logic computer is further configured to generate a second of the one or more questions based on the user's answer to a first of the one or more questions.

5. The system of claim 1, wherein the business logic computer is configured to invoke a predictive model to generate the one or more questions related to the life event.

6. The system of claim 5, wherein the questions generated by the predictive model are selected from a set of predefined questions stored in the database for the life event.

7. The system of claim 1, wherein the database is further configured to store a list of predefined questions for each kind of life event in a decision tree format.

8. The system of claim 1, wherein the policy adjustment includes one of changing one or more types of coverage set forth in the current policy and adding a new policy.

9. The system of claim 1, further comprising an underwriting server configured to process the policy adjustment determined by the business logic computer by at least one of accepting and denying the adjustments.

10. The system of claim 1, further comprising an underwriting server configured to determine a monthly premium associated with the adjusted policy determined by the business logic computer.

11. The system of claim 1, wherein the business logic computer is configured to bind the user to the adjusted policy upon the user accepting the adjustment.

12. The system of claim 1, wherein the indicated life event comprises a recent marriage of the policy holder.

13. A computerized method for determining an insurance policy adjustment based on information indicative of life events, comprising
receiving by a server a user indication of an occurrence of a life event experienced by the user;
storing in a database insurance parameter data associated with the user;
receiving by a computer the indication from the user via the server;
in response to receiving the indication, displaying by the computer one or more questions related to the indicated life event;
sending by the computer the one or more questions to the user via the server;
receiving by the computer from the user one or more answers associated with the one or more questions via the server; and
determining by the computer an insurance policy adjustment for the user's one or more insurance based on the one or more user answers and the indicated life event.

14. The computerized method of claim 13, further comprising receiving by the server a user selection of one of a pre-defined list of life events, wherein the predefined list of life events comprises at least two of getting married, getting divorced, and having a family member move out of the home.

15. The computerized method of claim 13, further comprising generating by the computer a second of the one or more questions based on the user's answer to a first of the one or more questions.

16. The computerized method of claim 13, further comprising invoking by the computer a predictive model to generate the one or more questions related to the life event.

17. The computerized method of claim 16, further comprising selecting the questions by the predictive model from a set of predefined questions stored in the database for the life event.

18. The computerized method of claim 13, further comprising storing in the database a list of predefined questions for each kind of life event in a decision tree format.

19. The computerized method of claim 13, wherein the policy adjustment includes one of changing one or more types of coverage set forth in the current policy and adding a new policy.

20. The computerized method of claim 13, further comprising determining by the computer a monthly premium associated with the adjusted policy.

21. The computerized method of claim 13, wherein the indicated life event comprises a recent marriage of the policyholder.

22. A non-transitory computer readable medium storing computer executable instructions, which, when executed by a processor, cause the processor to carry out a method, the method comprising:
receiving a user indication of an occurrence of a life event experienced by the user;
storing in a database insurance parameter data associated with the user;
receiving the indication from the user;
in response to receiving the indication, displaying one or more questions related to the indicated life event;
sending the one or more questions to the user;
receiving from the user one or more answers associated with the one or more questions; and
determining an insurance policy adjustment for the user's one or more insurance based on the one or more user answers and the indicated life event.

23. The non-transitory computer readable medium of claim 22, wherein the non-transitory computer readable medium further stores instructions for causing the processor to receive a user selection of one of a pre-defined list of life events and wherein the pre-defined list of events comprises at least two of getting married, getting divorced, and having a family member move out of the home.

24. The non-transitory computer readable medium of claim 22, wherein the non-transitory computer readable medium further stores instructions for causing the processor to generate a second of the one or more questions based on the user's answer to a first of the one or more questions.

25. The non-transitory computer readable medium of claim 22, wherein the non-transitory computer readable medium further stores instructions for causing the processor to invoke a predictive model to generate the one or more questions related to the life event.

26. The non-transitory computer readable medium of claim 25, wherein the non-transitory computer readable medium further stores instructions for causing the processor to select the questions by the predictive model from a set of predefined questions stored in the database for the life event.

27. The non-transitory computer readable medium of claim 22, wherein the non-transitory computer readable medium further stores instructions for causing the processor to store in the database a list of predefined questions for each kind of life event in a decision tree format.

28. The non-transitory computer readable medium of claim 22, wherein the policy adjustment includes one of changing one or more types of coverage set forth in the current policy and adding a new policy.

29. The non-transitory computer readable medium of claim 22, wherein the non-transitory computer readable medium further stores instructions for causing the processor to determine a monthly premium associated with the adjusted policy.

30. The non-transitory computer readable medium of claim 22, wherein the indicated life event comprises a recent marriage of the policy holder.
